(19) United States
(12) Patent Application Publication
(10) Pub. No.: US 2023/0281642 A1
(43) Pub. Date: Sep. 7, 2023

(54) SYSTEMS AND METHODS FOR CONTENT DISTRIBUTION WITHOUT TRACKING

(71) Applicant: ADOBE INC., SAN JOSE, CA (US)

(72) Inventors: Shiv Shankar, Amherst, MA (US); Sridhar Mahadevan, Morgan Hill, CA (US); Moumita Sinha, Cupertino, CA (US); Ritwik Sinha, Cupertino, CA (US); Saayan Mitra, San Jose, CA (US); Viswanathan Swaminathan, Saratoga, CA (US); Erin Davis, Boise, ID (US)

(21) Appl. No.: 17/653,157

(22) Filed: Mar. 2, 2022

(51) Int. Cl. G06Q 30/02

(52) U.S. Cl. CPC G06Q 30/0201

(57) ABSTRACT

A system and method for content distribution without tracking is described. The system and method includes determining that device identifiers are not available for a first digital content channel; identifying a first cluster of users and a second cluster of users based on the determination that device identifiers are not available; providing first content and second content via the first digital content channel; monitoring user interactions on the first digital content channel to obtain a first conversion rate for users in the first cluster that receive the first content and a second conversion rate for users in the second cluster that receive the second content; computing a cross-cluster treatment effect based on the first conversion rate and the second conversion rate; computing a treatment effect for the first content based on the cross-cluster treatment effect; and providing the first content to a subsequent user based on the treatment effect.

### BACKGROUND

The following relates generally to content distribution, and more specifically to content distribution without tracking.

Content distribution refers to various processes for providing users of Internet services such as the world wide web, email, etc., with digital content such as text, images, and videos. Conventional content distribution systems and methods attempt to ensure that users are provided with content that is consistent with their browsing habits by tracking the users via device identifiers such as HTTP cookies and/or mobile device identifiers.

However, the use of device identifiers such as cookies and mobile device identifiers for tracking Internet user activity is being deprecated, which may prevent content from being distributed to users in a consistent and effective manner.

### SUMMARY

A method and system for content distribution without tracking are described. One or more aspects of the method and system include determining, by a monitoring component, that device identifiers used for user tracking are not available for a first digital content channel; identifying, by a clustering component, a first cluster of users and a second cluster of users based on the determination that device identifiers are not available, wherein each user in the first cluster and the second cluster receives digital content from the first digital content channel; providing, by a content distribution component, first content and second content via the first digital content channel; monitoring user interactions on the first digital content channel to obtain a first conversion rate for users in the first cluster that receive the first content and a second conversion rate for users in the second cluster that receive the second content; computing, by a treatment effect component, a cross-cluster treatment effect based on the first conversion rate and the second conversion rate; computing, by the treatment effect component, a treatment effect for the first content based on the cross-cluster treatment effect; and providing, by the content distribution component, the first content to a subsequent user based on the treatment effect.

A method and system for content distribution without tracking are described. One or more aspects of the method and system include identifying, by a clustering component, a first cluster of users and a second cluster of users based on determining that device identifiers used for user tracking are not available for a first digital content channel and a second digital content channel, wherein each user in the first cluster and the second cluster receives digital content from the first digital content channel or the second digital content channel; providing, by a content distribution component, first content and second content via the first digital content channel; providing, by the content distribution component, third content and fourth content via the second digital content channel; monitoring, by a monitoring component, user interactions on the first digital content channel and the second digital content channel to obtain a first conversion rate for users in the first cluster that receive the first content, a second conversion rate for users in the second cluster that receive the second content, a third conversion rate for users in the first cluster that receive the third content, and a fourth conversion rate for users in the second cluster that receive the fourth content; computing, by a treatment effect component, a cross-cluster treatment effect based on the first conversion rate, the second conversion rate, the third conversion rate, and the fourth conversion rate; computing, by the treatment effect component, a treatment effect for the first content, the second content, the third content and the fourth content based on the cross-cluster treatment effect; and providing, by the content distribution component, the first content, the second content, the third content or the fourth content to a subsequent user based on the treatment effect.

An apparatus and system for content distribution without tracking are described. One or more aspects of the apparatus and system include a clustering component configured to identify a first cluster of users and a second cluster of users, wherein each user in the first cluster and the second cluster receives digital content from a first digital content channel; a monitoring component configured to monitor user interactions on the first digital content channel to obtain a first conversion rate for users in the first cluster that receive first content and a second conversion rate for users in the second cluster that receive second content; and a treatment effect component configured to compute a cross-cluster treatment effect based on the first conversion rate and the second conversion rate, and a treatment effect for the first content based on the cross-cluster treatment effect.

### BRIEF DESCRIPTION OF THE DRAWINGS

FIG. 1 shows an example of content distribution without tracking according to aspects of the present disclosure.

FIG. 2 shows an example of content distribution over multiple channels according to aspects of the present disclosure.

FIG. 3 shows an example of variable content distribution over different channels according to aspects of the present disclosure.

FIG. 4 shows an example of user clustering and treatment over multiple channels according to aspects of the present disclosure.

FIG. 5 shows an example of a content distribution system according to aspects of the present disclosure.

FIG. 6 shows an example of a content distribution apparatus according to aspects of the present disclosure.

FIG. 7 shows an example of computing a treatment effect according to aspects of the present disclosure.

### DETAILED DESCRIPTION

The present disclosure describes systems and methods for content distribution that can consistently provide content to users without tracking the user via device identifiers such as cookies and mobile device identifiers.

Content distribution refers to various processes for providing users of Internet services such as the world wide web, email, etc., with digital content such as text, images, and videos. Conventional content distribution systems and methods attempt to ensure that users are provided with content that is consistent with their browsing habits by tracking the users via device identifiers such as HTTP cookies and/or mobile device identifiers. Cookies are data provided from a server to a user device when a browser accesses a website. A cookie allows the server to track the user's activity on the Internet, such as clicks, log-ins, and the user's browsing history. Mobile device identifiers are data that is unique to a mobile device that is provided to a content distribution server after the user device installs an application from the content distribution server.

However, the use of device identifiers such as cookies and mobile device identifiers for monitoring user activity is being deprecated, which may prevent content from being distributed to users in a consistent and effective manner. For example, a conventional content distribution system relies on third-party cookies to know which websites a user has visited and which content the user has interacted with on those websites, so that the user may be provided with similar or relevant content across all websites that the conventional content distribution system provides content for. If the conventional content distribution system is not able to use cookies to track the user in this manner, then it will not know what content the user has been exposed to and interacted with, which removes the ability of the conventional content distribution system to provide the user with targeted content, thereby lessening the desired effect of the content on the user.

Therefore, at least one embodiment of the present disclosure distributes first content to a subsequent user based on a treatment effect that is computed based on a cross-cluster treatment effect that is in turn based on a first conversion rate and a second conversion rate, where the first conversion rate is for users in a first cluster that receive the first content and the second conversion rate is for users in a second cluster that receive second content. The at least one embodiment of the present disclosure obtains the first and second conversion rates by monitoring user interactions with a digital content channel, such as a website, and identifies the first and second clusters of users based on determining that device identifiers used for user tracking are not available for the digital content channel.

At least one embodiment of the inventive concept is used in a content distribution context. For example, a content distributor may want to distribute content on digital content channels such as websites with a reliable degree of foreknowledge of how many conversions the content will produce per user (the content's conversion rate). When a content distributor has access to information such as third-party cookies and mobile device identifiers, a content distributor can reliably predict conversions for particular individual users based on the users' past activity across multiple digital content channels. Because the content distributor has access to the tracking information, the content distributor knows exactly how the user has interacted with multiple digital content channels, such as hyperlink clicks and purchases made, and based on that knowledge, can provide content to specific users and digital content channels in a manner that will lead to a predicted highest conversion rate. However, the use of third-party cookies and mobile device identifiers for this purpose are being deprecated by prominent web browsers. The content distributor may instead use at least one embodiment of the inventive concept to determine that third-party cookies are not available, monitor user cluster activity on one or more digital content channels to identify conversion rates, determine a treatment effect based on the conversion rates, and distribute content to subsequent users, thereby distributing content using a reliable estimate of conversion rates even where user tracking is unavailable.

A treatment effect refers to a representation of the effect on user behavior of shifting from one treatment (e.g., exposure of a user to first content) to another (e.g., exposure of the user to second content). For example, clusters of users may receive different treatments by being exposed to different digital content on different digital content channels. A treatment effect measures a difference in outcome (such as a conversion rate) when a user or a cluster of users is provided with first content and when the user or cluster of users is provided with different content. The treatment effect may include one or more cross-cluster treatments, which are factors that identify differences in conversion rates between clusters of users.

For example, the at least one embodiment of the inventive concept identifies user clusters (e.g., groups of visitors to a digital content channel such as a website) using a clustering component after determining that user identifiers used for user tracking such as third-party cookies or mobile device identifiers are not available (e.g., a monitoring component of the at least one embodiment of the inventive concept may request third-part cookies from the website and may be denied in response to the request). The users may be clustered on various bases, such as time of visit to the digital content channel, IP addresses (which provide a general geographic location for a device accessing a digital content channel, and can be aggregated to form larger geographic groupings), first-party cookies, identification APIs, and other aggregate identification information that web browsers make available to the clustering component.

A content distribution component then provides first content and second content via the digital content channel (e.g., website visitors in a first cluster of users see a first collection of content, or treatment, such as images, audio, video, hyperlinks, and the like displayed on the website, while website visitors in a second cluster of users see a second collection of content). The monitoring component monitors user interactions on the digital content channel to obtain a first conversion rate for users in the first cluster that receive the first content and a second conversion rate for users in the second cluster that receive the second content. For example, the monitoring component records purchases from website visitors in the first cluster of users who see the first content and purchases from website visitors in the second cluster of users who see the second content.

A treatment effect component computes a cross-cluster treatment effect based on the first conversion rate and the second conversion rate, and then computes a treatment effect for the first content based on the cross-cluster treatment effect. By doing so, the at least one embodiment of the inventive concept is able to develop and implement a model that can be used to distribute content to subsequent visitors to the website in a predictable manner that closely mimics a treatment effect that would be calculated given an ability to track individual users across digital content channels.

Therefore, in contrast with conventional content distribution systems, at least one embodiment of the inventive concept advantageously allows a content distributor to provide content to users via digital content channels such as websites in a controlled and precise manner when individual device identifiers such as third-party cookies and mobile device identifiers are not available for tracking individual users. The at least one embodiment of the inventive concept calculates a treatment effect using a treatment effect component based on user clusters identified by a clustering component. The clustering component and the treatment effect component provide a content distribution component with the information needed to provide content to subsequent users who visit digital content channels that display the first content in a controlled manner that promotes high conversion rates.

The term “cluster” refers to a group of users who are grouped based on non-personally identifying information or personal information that is limited to being shared with one particular digital content channel, such as time of visit to the digital content channel, IP addresses (which provide a general geographic location for a device accessing a digital content channel, and can be aggregated to form larger geographic groupings), first-party cookies, identification APIs, and other aggregate identification information that web browsers make available.

The term “content” refers to data, information, and media that may be displayed on a digital content channel, such as text, audio, images, and videos. The content may take the form of hyperlinks.

The term “digital content channel” refers to a channel that is accessible via a computer and is capable of displaying the content. Examples of a digital content channel include a website and an email service.

The term “conversion rate” refers to the rate of conversions (i.e., purchases) made per user that receives content relating to the purchase. For example, a first content may include hyperlinks to a purchase webpage that allows a user to confirm a purchase, and the conversion rate would be determined based on the number of users that confirm the purchase per the total number of users that have received the first content.

The term “treatment effect” refers to a representation of the effect on user behavior of a “treatment” such as displaying content to the user. A treatment effect can also be used to describe the effect of shifting from one treatment (e.g., exposure of a user to first content) to another (e.g., exposure of the user to second content).

The term “cross-cluster treatment effect” refers to a factor in a treatment effect that incorporates differences between outcomes between clusters of users (e.g., differences in the conversion rates resulting from a received content).

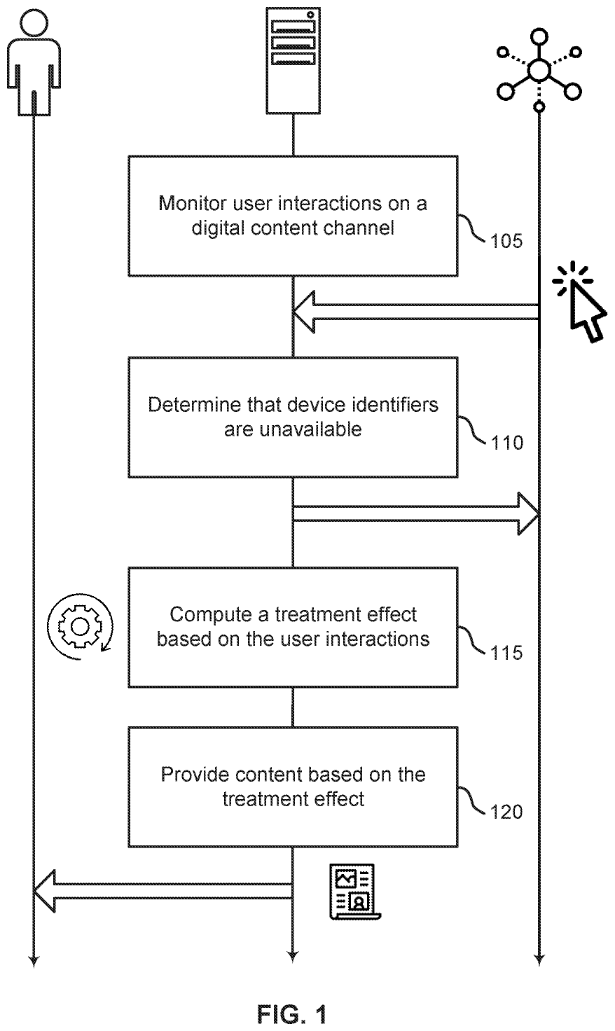

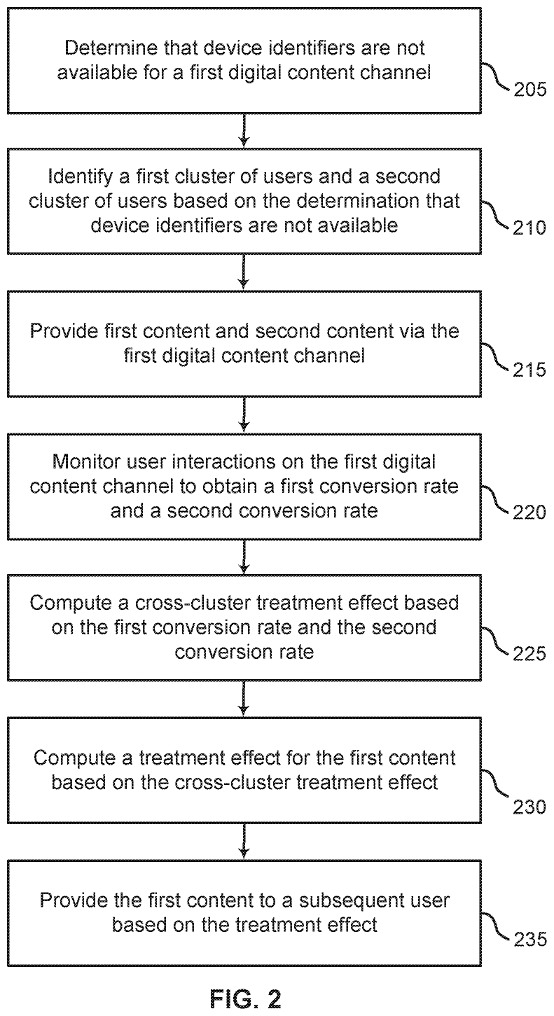

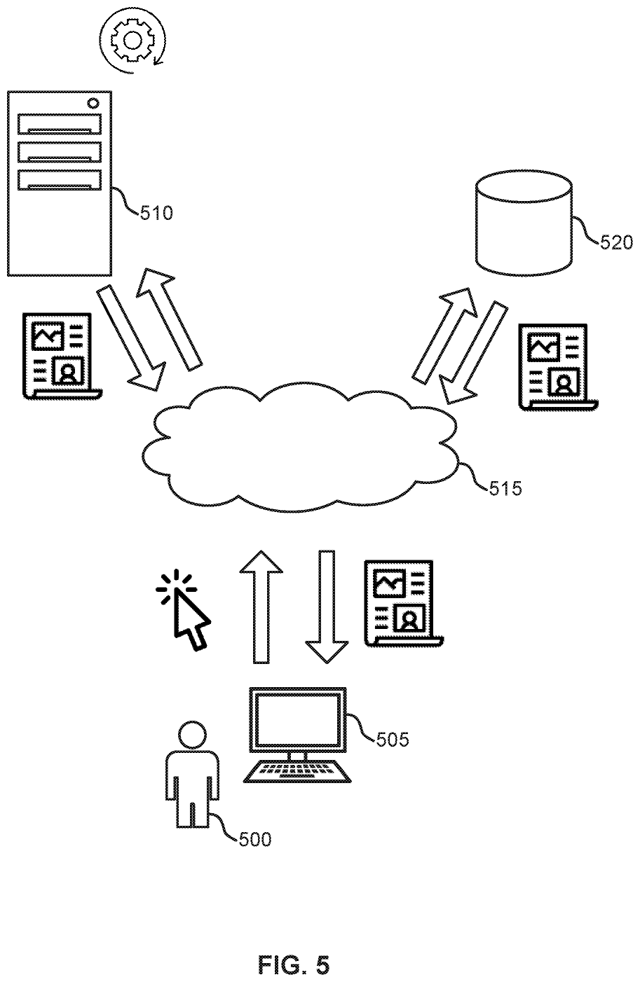

An example application of the inventive concept in the content distribution context is provided with reference to FIGS. 1 and 5. Examples of a process for content distribution without tracking are provided with reference to FIGS. 2-4. Details regarding the architecture of an example content distribution apparatus are provided with reference to FIGS. 5-7.

### Content Distribution

A method for content distribution without tracking is described. One or more aspects of the method include determining, by a monitoring component, that device identifiers used for user tracking are not available for a first digital content channel; identifying, by a clustering component, a first cluster of users and a second cluster of users based on the determination that device identifiers are not available, wherein each user in the first cluster and the second cluster receives digital content from the first digital content channel; providing first content and second content via the first digital content channel; monitoring, by the monitoring component, user interactions on the first digital content channel to obtain a first conversion rate for users in the first cluster that receive the first content and a second conversion rate for users in the second cluster that receive the second content; computing, by a treatment effect component, a cross-cluster treatment effect based on the first conversion rate and the second conversion rate; computing, by the treatment component, a treatment effect for the first content based on the cross-cluster treatment effect; and providing, by the content distribution component, the first content to a subsequent user based on the treatment effect.

Some examples of the method further include monitoring, by the monitoring component, the first digital content channel to obtain a third conversion rate for users in the first cluster that receive the second content and a fourth conversion rate for users in the second cluster that receive the first content. Some examples further include computing, by the treatment effect component, an additional cross-cluster treatment effect based on the third conversion rate and the fourth conversion rate. Some examples further include weighting, by the treatment effect component, the cross-cluster treatment effect and the additional cross-cluster treatment effect, wherein the treatment effect is based on the weighted cross-cluster treatment effect and the weighted additional cross-cluster treatment effect.

Some examples of the method further include identifying, by the content distribution component, a weighting parameter. Some examples further include providing, by the content distribution component, the first content to a first portion of the first cluster via the first digital channel based on the weighting parameter. Some examples further include providing, by the content distribution component, the second content to a second portion of the first cluster via the first digital channel based on a complement of the weighting parameter, wherein the treatment effect is computed based on the weighting parameter.

Some examples of the method further include providing, by the content distribution component, the first content to a first portion of the second cluster via the first digital channel based on the complement of the weighting parameter. Some examples further include providing, by the content distribution component, the second content to a second portion of the second cluster via the first digital channel based on the weighting parameter.

Some examples of the method further include providing, by the content distribution component, the first content and the second content on a second digital content channel, wherein the cross-cluster treatment effect is based on providing the first content and the second content on the second digital content channel. Some examples of the method further include identifying, by the content distribution component, a weighting parameter. Some examples further include providing, by the content distribution component, the first content to a first portion of the first cluster via the second digital channel based on a complement of the weighting parameter. Some examples further include providing, by the content distribution component, the second content to a second portion of the first cluster via the second digital channel based on the weighting parameter.

Some examples of the method further include providing, by the content distribution component, the first content to a first portion of the second cluster via the second digital channel based on the weighting parameter. Some examples further include providing, by the content distribution component, the second content to a second portion of the second cluster via the second digital channel based on a complement of the weighting parameter. Some examples of the method further include performing, by the treatment effect component, a covariate adjustment based on the treatment effect.

Some examples of the method further include identifying, by the monitoring component, a condition of users in the first cluster and the second cluster. Some examples further include monitoring, by the monitoring component, the first digital content channel to obtain a first conditional conversion rate for users in the first cluster that satisfy the condition and receive the first content and a second conditional conversion rate for users in the second cluster that satisfy the condition and receive the second content. Some examples further include computing, by the treatment effect component, a conditional average treatment effect based on the first conditional conversion rate and the second conditional conversion rate.

Some examples of the method further include identifying, by the monitoring component, location information for users of the first digital content channel and the second digital content channel, wherein the first cluster and the second cluster are identified based on the location information.

A method for content distribution without tracking is described. One or more aspects of the method include identifying, by a clustering component, a first cluster of users and a second cluster of users based on determining that device identifiers used for user tracking are not available for a first digital content channel and a second digital content channel, wherein each user in the first cluster and the second cluster receives digital content from the first digital content channel or the second digital content channel; providing, by a content distribution component, first content and second content via the first digital content channel; providing, by the content distribution component, third content and fourth content via the second digital content channel; monitoring, by a monitoring component, user interactions on the first digital content channel and the second digital content channel to obtain a first conversion rate for users in the first cluster that receive the first content, a second conversion rate for users in the second cluster that receive the second content, a third conversion rate for users in the first cluster that receive the third content, and a fourth conversion rate for users in the second cluster that receive the fourth content; computing, by a treatment effect component, a cross-cluster treatment effect based on the first conversion rate, the second conversion rate, the third conversion rate, and the fourth conversion rate; computing, by the treatment effect component, a treatment effect for the first content, the second content, the third content and the fourth content based on the cross-cluster treatment effect; and providing, by the content distribution component, the first content, the second content, the third content or the fourth content to a subsequent user based on the treatment effect.

Some examples of the method further include identifying, by the content distribution component, a weighting parameter. Some examples further include providing, by the content distribution component, the first content to a first portion of the first cluster via the first digital channel based on the weighting parameter. Some examples further include providing, by the content distribution component, the second content to a second portion of the first cluster via the first digital channel based on a complement of the weighting parameter, wherein the treatment effect is computed based on the weighting parameter.

Some examples of the method further include providing, by the content distribution component, the first content to a first portion of the second cluster via the first digital channel based on the complement of the weighting parameter. Some examples further include providing, by the content distribution component, the second content to a second portion of the second cluster via the first digital channel based on the weighting parameter.

Some examples of the method further include providing, by the content distribution component, the third content to a first portion of the first cluster via the second digital channel based on a complement of the weighting parameter. Some examples further include providing, by the content distribution component, the fourth content to a second portion of the first cluster via the second digital channel based on the weighting parameter.

Some examples of the method further include providing, by the content distribution component, the third content to a first portion of the second cluster via the second digital channel based on the weighting parameter. Some examples further include providing, by the content distribution component, the fourth content to a second portion of the second cluster via the second digital channel based on a complement of the weighting parameter. Some examples of the method further include performing, by the treatment effect component, a covariate adjustment on the treatment effect.

Some examples of the method further include identifying, by the monitoring component, a condition of users in the first cluster and the second cluster. Some examples further include monitoring, by the monitoring component, the first digital content channel to obtain a first conditional conversion rate for users in the first cluster that satisfy the condition and receive the first content, a second conditional conversion rate for users in the second cluster that satisfy the condition and receive the second content, a third conversion rate for users in the first cluster than satisfy the condition and receive the third content, and a fourth conversion rate for users in the second cluster that satisfy the condition and receive the second content. Some examples further include computing, by the treatment effect component, conditional average treatment effects based on the first conditional conversion rate, the second conditional conversion rate, the third conditional conversion rate, and the fourth conditional conversion rate.

FIG. 1 shows an example of content distribution without tracking according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

FIG. 1 shows an example application of the inventive concept in the content distribution context. For example, a content distributor can use the inventive concept to predict a user response to content and distribute the content to the user based on the prediction, even when a cross-website response to the content by the user cannot be determined because user-tracking methods such as third-party cookies and mobile device identifiers are not available to the content distributor.

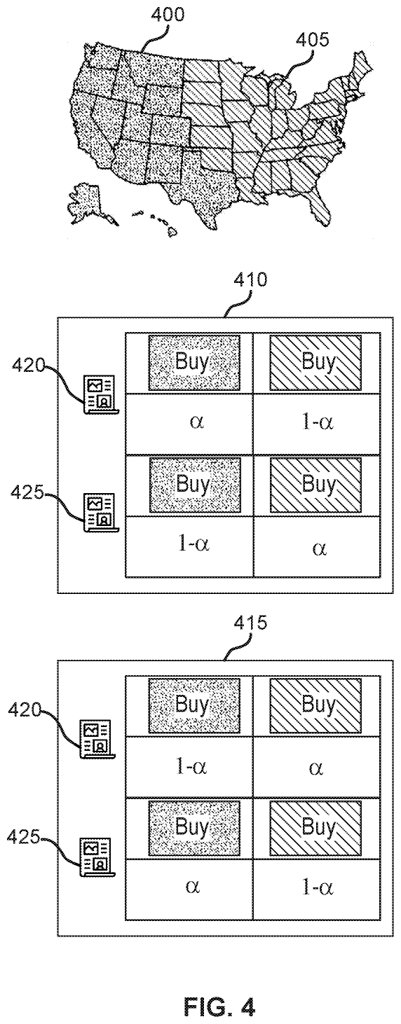

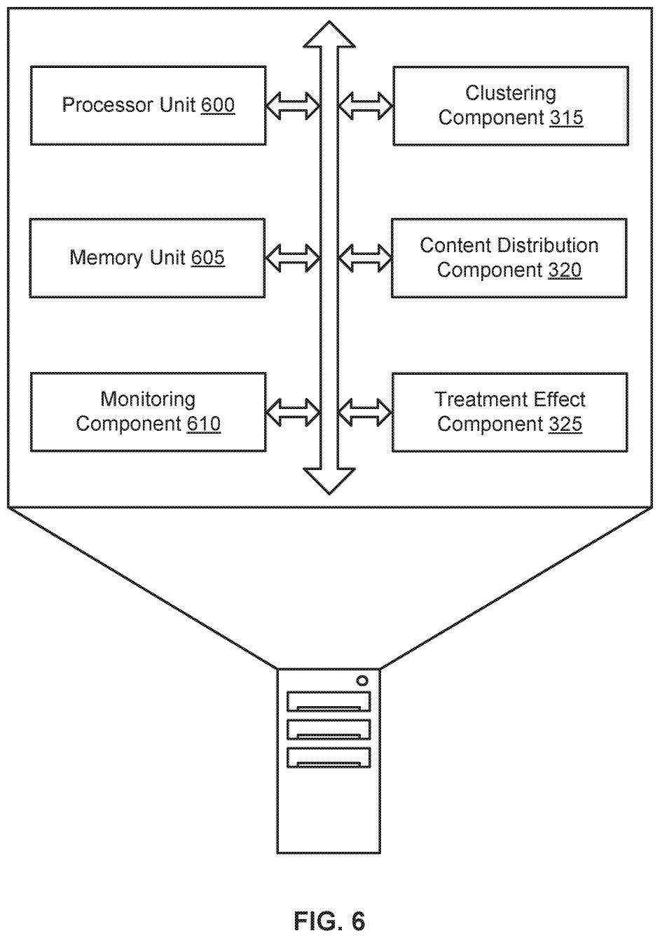

At operation 105, the system monitors user interactions on a digital content channel. In some cases, the operations of this step refer to, or may be performed by, a content distribution apparatus as described with reference to FIGS. 5-6. For example, the content distribution apparatus may monitor user interactions on the digital content channel as described with reference to FIG. 4.

At operation 110, the system determines that device identifiers used for user tracking are unavailable. In some cases, the operations of this step refer to, or may be performed by, a content distribution apparatus as described with reference to FIGS. 5-6. For example, the content distribution apparatus may determine that device identifiers used for user tracking are unavailable as described with reference to FIG. 4.

At operation 115, the system computes a treatment effect. In some cases, the operations of this step refer to, or may be performed by, a content distribution apparatus as described with reference to FIGS. 5-6. For example, the content distribution apparatus may compute a treatment effect as described with reference to FIG. 4.

At operation 120, the system provides first content based on the treatment effect. In some cases, the operations of this step refer to, or may be performed by, a content distribution apparatus as described with reference to FIGS. 5-6. For example, the content distribution apparatus may provide first content based on the treatment effect as described with reference to FIG. 4.

FIG. 2 shows an example of content distribution over multiple channels according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

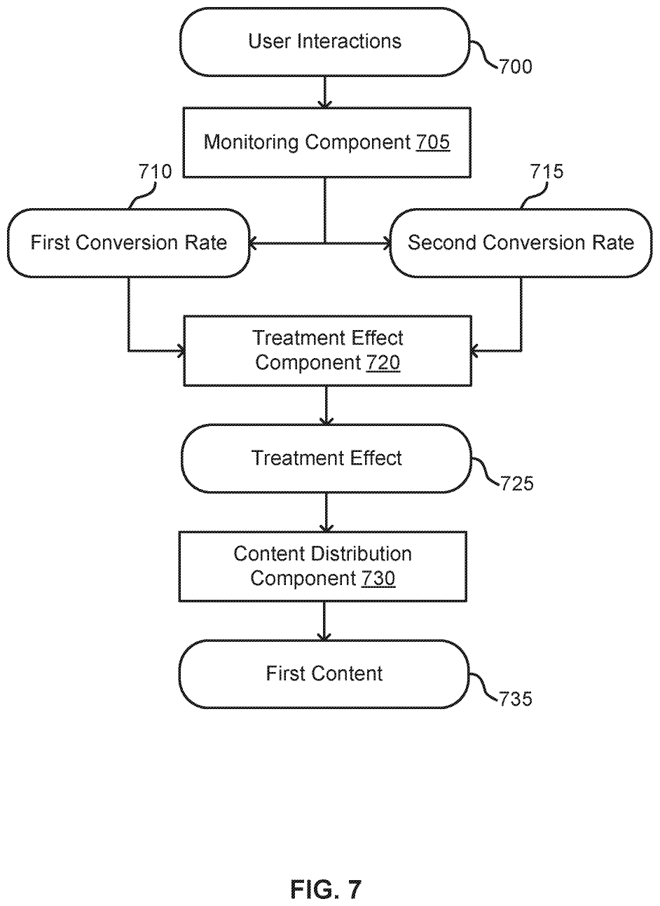

At operation 205, the system determines that device identifiers used for user tracking are not available for a first digital content channel. In some cases, the operations of this step refer to, or may be performed by, a monitoring component as described with reference to FIGS. 6 and 7. For example, the monitoring component may determine that device identifiers used for user tracking are not available for a first digital content channel as described with reference to FIG. 4.

At operation 210, the system identifies a first cluster of users and a second cluster of users based on the determination that device identifiers are not available. In some cases, the operations of this step refer to, or may be performed by, a clustering component as described with reference to FIG. 6. For example, the clustering component may identify a first cluster of users and a second cluster of users based on the determination that device identifiers are not available as described with reference to FIG. 4.

At operation 215, the system provides first content and second content via the first digital content channel. In some cases, the operations of this step refer to, or may be performed by, a content distribution component as described with reference to FIGS. 6 and 7. For example, the content distribution component may provide first content and second content via the first digital content channel as described with reference to FIG. 4.

At operation 220, the system monitors user interactions on the first digital content channel to obtain a first conversion rate and a second conversion rate. In some cases, the operations of this step refer to, or may be performed by, a monitoring component as described with reference to FIGS. 6 and 7. For example, the monitoring component may monitor user interactions on the first digital content channel to obtain a first conversion rate and a second conversion rate as described with reference to FIG. 4.

At operation 225, the system computes a cross-cluster treatment effect based on the first conversion rate and the second conversion rate. In some cases, the operations of this step refer to, or may be performed by, a treatment effect component as described with reference to FIGS. 6 and 7. For example, the treatment effect component may compute a cross-cluster treatment effect based on the first conversion rate and the second conversion rate as described with reference to FIG. 4.

At operation 230, the system computes a treatment effect for the first content based on the cross-cluster treatment effect. In some cases, the operations of this step refer to, or may be performed by, a treatment effect component as described with reference to FIGS. 6 and 7. For example, the treatment effect component may compute a treatment effect for the first content based on the cross-cluster treatment effect as described with reference to FIG. 4.

At operation 235, the system provides the first content to a subsequent user based on the treatment effect. In some cases, the operations of this step refer to, or may be performed by, a content distribution component as described with reference to FIGS. 6 and 7.

For example, the content distribution component may provide the first content to a subsequent user based on the treatment effect as described with reference to FIG. 4.

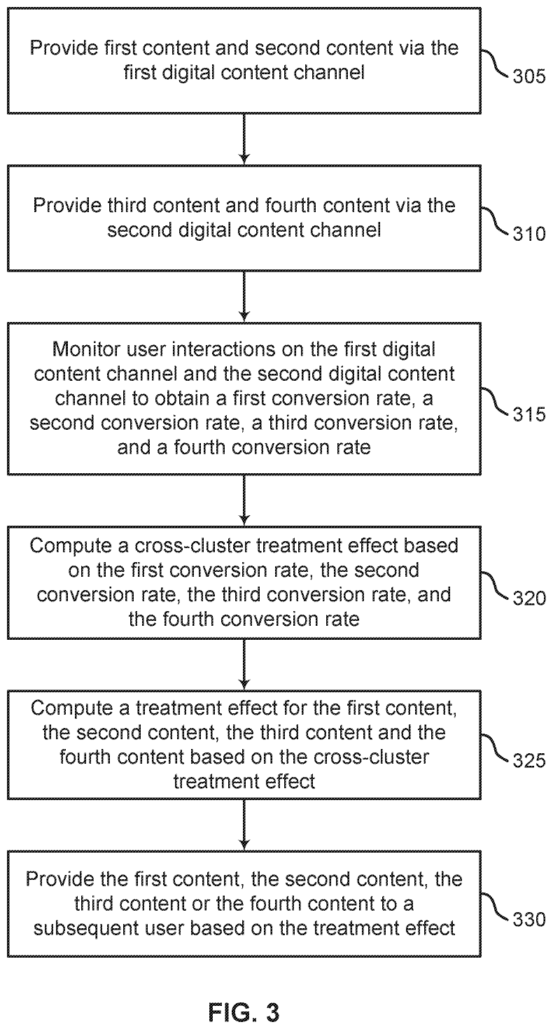

FIG. 3 shows an example of variable content distribution over different channels according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 305, the system provides first content and second content via the first digital content channel. In some cases, the operations of this step refer to, or may be performed by, a content distribution component as described with reference to FIGS. 6 and 7. For example, the content distribution component may provide first content and second content via the first digital content channel as described with reference to FIG. 4.

At operation 310, the system provides third content and fourth content via the second digital content channel. In some cases, the operations of this step refer to, or may be performed by, a content distribution component as described with reference to FIGS. 6 and 7. For example, the content distribution component may provide third content and fourth content via the second digital content channel as described with reference to FIG. 4.

At operation 315, the system monitors user interactions on the first digital content channel and the second digital content channel to obtain a first conversion rate, a second conversion rate, a third conversion rate, and a fourth conversion rate. In some cases, the operations of this step refer to, or may be performed by, a monitoring component as described with reference to FIGS. 6 and 7. For example, the monitoring component may monitor user interactions on the first digital content channel and the second digital content channel to obtain a first conversion rate, a second conversion rate, a third conversion rate, and a fourth conversion rate as described with reference to FIG. 4.

At operation 320, the system computes a cross-cluster treatment effect based on the first conversion rate, the second conversion rate, the third conversion rate, and the fourth conversion rate. In some cases, the operations of this step refer to, or may be performed by, a treatment effect component as described with reference to FIGS. 6 and 7. For example, the treatment effect component may compute a cross-cluster treatment effect based on the first conversion rate, the second conversion rate, the third conversion rate, and the fourth conversion rate as described with reference to FIG. 4.

At operation 325, the system computes a treatment effect for the first content, the second content, the third content and the fourth content based on the cross-cluster treatment effect. In some cases, the operations of this step refer to, or may be performed by, a treatment effect component as described with reference to FIGS. 6 and 7. For example, the treatment effect component may compute a treatment effect for the first content, the second content, the third content and the fourth content based on the cross-cluster treatment effect as described with reference to FIG. 4.

At operation 330, the system provides the first content, the second content, the third content or the fourth content to a subsequent user based on the treatment effect. In some cases, the operations of this step refer to, or may be performed by, a content distribution component as described with reference to FIGS. 6 and 7. For example, the content distribution component may provide the first content, the second content, the third content or the fourth content to a subsequent user based on the treatment effect.

### Treatment Effects and Cross-Cluster Treatment Effects

FIG. 4 shows an example of user clustering and treatment over multiple channels according to aspects of the present disclosure. The example shown includes first cluster of users 400, second cluster of users 405, first digital content channel 410, second digital content channel 415, first content 420, and second content 425.

Referring to FIG. 4, a content distributor may want to distribute content on digital content channels with a reliable degree of foreknowledge of how many conversions the content will produce per user (the content's conversion rate). When a content distributor has access to device identifiers such as third-party cookies and mobile device identifiers, a content distributor can reliably predict conversions for particular individual users based on the users' past activity. However, the use of third-party cookies and mobile device identifiers for this purpose are being deprecated by prominent web browsers. The content distributor may instead use at least one embodiment of the inventive concept to determine that device identifiers used for user tracking such as third-party cookies and mobile device identifiers are not available, monitor user cluster activity on one or more digital content channels to identify conversion rates, determine a treatment effect based on the conversion rates, and distribute content to subsequent users, thereby distributing content using a reliable estimate of conversion rates even where user tracking is unavailable.

A monitoring component as described with reference to FIGS. 6 and 7 may determine that device identifiers used for user tracking are not available for first digital content channel 410 and other digital content channels such as a second digital content channel. For example, the monitoring component may send a cookie request to a web browser when the browser attempts to access first digital content channel 410. The cookie request may include a request for the web browser to store the cookie. A cookie may be either a first-party cookie or a third-party cookie. A cookie is associated with a particular domain and scheme. If the domain and scheme of a cookie match a digital content channel associated with a cookie request, the cookie is a first-party cookie. If the domain and scheme of a cookie do not match a digital content channel associated with the cookie request, the cookie is a third-party cookie. A digital content channel host may attempt to set both first-party cookies and third-party cookies based on content displayed on the digital content channel (where content hosted by the digital content channel host relates to first-party cookies and content hosted by a different host relates to third-party cookies). Third-party cookies allow an entity to perform cross-site tracking based on the information that is provided by cookies that are stored in a user's browser and are shared with the entity. However, the use of third-party cookies is being reduced towards deprecation by prominent web browsers. The monitoring component may therefore receive a response from the web browser that a cookie request relating to first digital content channel 410 has been denied.

A clustering component as described with reference to FIG. 6 may identify first cluster of users 400 and second cluster of users 405 based on the determination that device identifiers are not available. For example, after a web browser has denied the monitoring component's cookie request to use third-party cookies, the clustering component may instead identify clusters of users using alternative methods of general identification of users of a particular digital content channel, such as by clustering according to time of visit, IP addresses (which provide a general geographic location for a device accessing a digital content channel, and can be aggregated to form larger geographic groupings), first-party cookies, identification APIs, and other aggregate identification information that web browsers make available. Referring to FIG. 4, first cluster of users 400 and second cluster of users 405 are visitors to a digital content channel such as first digital content channel 410 and have been identified on a geographic basis (for example, via IP addresses) by the clustering component after the monitoring component has determined that third-party cookies are not available for use with first digital content channel 410 and second digital content channel 415 to track the visitors.

A content distribution component as described with reference to FIGS. 6 and 7 may provide first content 420 and second content 425 via first digital content channel 410 and third content and fourth content via second digital content channel 415. For example, first digital content channel 410 may be visited by a set A of users and second digital content channel 415 may be visited by a set B of users. [symbol] 109 [symbol] ≠Ø, so some users will visit both digital content channels. When third-party cookies are available, these sets of users will get a consistent view of both digital content channels in terms of content, but without third-party cookies, this consistent view cannot be guaranteed. As such, a user may be exposed to multiple treatments (e.g., arrangement of content on a digital content channel). A similar situation can also arise with limited first-party cookies. If the first-party cookies are only session-level cookies (e.g., only stored by a web browser while the digital content channel is active in the web browser), a user cannot be tracked across visits, and therefore may be exposed to multiple treatments.

Given two digital content channels, each user uᵢ∈ [symbol] can be exposed to two treatments labeled 1 and 2 on the first digital content channel. Similarly, each user uᵢ∈ [symbol] can be exposed to two treatments labeled 3 and 4 on the second digital content channel. If the user uᵢ∈ [symbol] ∩ [symbol] , then they have exposure to treatments from both digital content channels. On the other hand, those users in [symbol] Δ [symbol] are only exposed to one treatment, and those users' exposure to treatments on the other digital content channel may be labeled as 0. Therefore, each user uᵢ∈ [symbol] may have 6 potential outcome variables: Y_{1,0}, Y_{2,0}, Y_{1,3}, Y_{1,4}, Y_{2,3}, Y_{2,4}. Of these six variables, only one is observed for each user based on the which treatment they receive.

Accordingly, the content distribution component may provide first content 420 and second content 425 via first digital channel 410 to first cluster of users 400 and second cluster of users 405, such that a visitor to first digital channel 410 receives either first content 420 or second content 425. Similarly, the content distribution component may similarly provide the third content and the fourth content via second digital content channel 415. However, as device identifiers such as third-party cookies or other information that can be used in tracking are not available, the content distribution component cannot provide targeted content based on individual user identities.

The monitoring component may monitor user interactions on first digital content channel 410 to obtain a first conversion rate for first cluster of users 400 that receive first content 420 and a second conversion rate for second cluster of users 405 that receive second content 425. The monitoring component may monitor user interactions on second digital content channel 415 to obtain a third conversion rate for first cluster of users 400 that receive the third content and a fourth conversion rate for second cluster of users 405 that receive the fourth content. For example, the monitoring component may receive information such as first-party cookies or may use protocols such as anonymous tracking APIs (such as the Attribution Reporting API and the Aggregated Reporting API) that enable the monitor component to observe user behavior on a digital content channel in one session in isolation from user behavior in on other content channels or in other sessions (such as time spent on the digital content channel, hyperlink clicks, content interaction, and conversion rates, i.e., purchases made per visit to the digital content channel).

A treatment effect component as described with reference to FIGS. 6 and 7 may compute a cross-cluster treatment effect based on the first conversion rate and the second conversion rate. The treatment effect may compute a cross-cluster treatment effect based on the first conversion rate, the second conversion rate, the third conversion rate, and the fourth conversion rate.

As discussed above, because the content distribution apparatus has determined that device identifiers such as third-party cookies and other individual identifiers are unavailable, the content distribution apparatus does not know if a user uᵢ ∈| [symbol] ∩ [symbol] |. In other words, the content distribution apparatus can observe outcome variables Y_{1,0}, Y_{1,3} or Y_{1,4} for a user u of first digital content channel 410, but does not know which of the outcome variables it is observing.

The expected average outcome (e.g., conversion) for a group of users that has been provided first content 420 via first digital content channel 410 is given by:

[symbol]

[Y̅₁]=(1−p) [symbol] [Y_{1,0}]+p(α [symbol] [Y_{1,3}]+(1−α) [symbol] [Y_{1,4}]) (1)

where p is the fraction of users uᵢ∈ [symbol] ∩ [symbol] who therefore receive both first content 420 and second content 425, while a is the fraction of users uᵢ∈ [symbol] ∩ [symbol] who receive first content 420 on second digital content channel 415 as well. Each user has the probability 1−p of only visiting first digital content channel 410 and therefore consistently receiving first content 420. For these users, the average outcome is [symbol] [Y_{1,0}]. An α fraction of the remaining p fraction of the population may be provided third content via second digital content channel 415 (and hence are exposed to treatment pair 1,3). The observed outcome on these users is represented by [symbol] [Y_{1,3}]. Similarly, a 1−α fraction of users uᵢ∈ [symbol] ∩ [symbol] may be provided fourth content via second digital content channel 415 and produce the average outcome [symbol] [Y_{1,4}]. An observed average effect is the probability weighted combination of all the contributions. Furthermore, by symmetry between the treatments:

[symbol]

[Y̅₂]=(1−p) [symbol] [Y_{2,0}]+p(α [symbol] [Y_{2,3}]+(1−α) [symbol] [Y_{2,4}]) (2)

where Y̅₂ is the average outcome of users provided with second content 425 by first digital content channel 410. From these equations, the standard observed treatment effect (e.g., the increase in conversion resulting from providing first content 420 instead of second content 425) is given by:

(1−p) [symbol] [Y_{1,0}−Y_{2,0}]+p(α [symbol] [Y_{1,3}−Y_{2,3}]+(1−α) [symbol] [Y_{1,4}−Y_{2,4}]) (3)

By comparison, in a case in which device identifiers such as third-party cookies or mobile device identifiers are available for tracking individual users and content is therefore distributed on a consistent basis, every user has a probability 1−p of only visiting a first digital content channel and hence receiving consistently either first content or second content. For these users, the treatment effect is given by [symbol] [Y_{1,0}−Y_{2,0}]. The remaining p users consistently receive the first content on the first digital content channel and the second digital content channel (e.g., treatment pair 1,3) or the second content on the first digital content channel and the second digital content channel (e.g., treatment pair 2,4). The corresponding treatment effect is given by IE [Y_{1,3}−Y_{2,4}]. The average comparative treatment effect CTE in this case, then, is a population weighted combination of the two contributions:

CTE=(1−p) [symbol] [Y_{1,0}−Y_{2,0}]+p( [symbol] [Y_{1,3}−Y_{2,4}]) (4)

The comparative treatment effect given cross-channel tracking and the standard observed treatment effect given an unavailability of cross-channel tracking are mismatched due to contributions from the cross treatment outcomes Y_{2,3} and Y_{1,4}. Moreover, the mismatch increases with p, e.g., the fraction of users shared between the two digital content channels.

Accordingly, the treatment effect component may compute a cross-cluster treatment effect based on the first conversion rate and the second conversion rate:

Y̅₁^{C1}−Y̅₂^{C2} (5)

where Y̅ⱼ^{Ci} is the observed average outcomes for user cluster Ci and treatment j.

Furthermore, the treatment effect component may compute a cross-cluster treatment effect based on the first conversion rate, the second conversion rate, the third conversion rate, and the fourth conversion rate:

α(Y̅₁^{C1}−Y̅₂^{C2})+(α−1)(Y̅₁^{C2}−Y̅₂^{C1}) (6)

where α≠0.5 is the allocation ratio of third content and fourth content to second digital content channel 415 for first cluster of users 400 by the content distribution component (e.g., a weighting parameter identified based on identifying content provided to second digital content channel 415) and 1−α is the allocation ratio of third content and fourth content to second digital content channel 415 for second cluster of users 405 (e.g., a complement of the weighting parameter).

### Treatment Effect

The treatment effect component may compute a treatment effect for first content 420 based on the cross-cluster treatment effect, and the treatment effect component may compute a treatment effect for first content 420, second content 425, the third content and the fourth content based on the cross-cluster treatment effect:

$$= \frac{1}{2 α - 1} [ α ( {\overline{Y}}_{1}^{C 1} - {\overline{Y}}_{2}^{C 2} ) + ( α - 1 ) ( {\overline{Y}}_{1}^{C 2} - {\overline{Y}}_{2}^{C 1} ) ] \qquad ( 7 )$$

This treatment effect [symbol] is an unbiased estimate of the comparative treatment effect CTE that can be used by the content distribution apparatus to reliably predict a conversion outcome for a user viewing content on a digital content channel even where individual device identifiers such as third-party cookies are not available for the digital content channel.

The content distribution component may provide first content 420, second content 425, the third content, or the fourth content to a subsequent user based on the treatment effect. For example, based on the treatment effect, the content distribution component has an unbiased estimate of the comparative treatment effect in a case in which third-party cookies are available for tracking individual users and content is therefore distributed on a consistent basis, and may therefore choose to distribute first content 420, second content 425, the third content or the fourth content to a subsequent user (e.g., a visitor to a digital content channel displaying content distributed by the content distribution component subsequent to the treatment effect component's determination of the treatment effect) via one or more digital content channels (e.g., by displaying the content on the digital content channel) with a reliable estimate of the conversion rate that the content will produce.

In some examples, the content distribution component provides first content 420 and second content 425 on second digital content channel 415, where the cross-cluster treatment effect is based on providing first content 420 and second content 425 on second digital content channel 415. For example, a user may be provided with first content 420 on first digital channel 410 and second content 425 on second digital content channel 415. In this case, the difference in content that a user sees (for example, different prices or discounts for a same product) on different digital content channels can negatively impact the likelihood of conversion, and so the cross-cluster treatment effect takes this possibility into account.

In some examples, the content distribution component provides first content 420 to a first portion of first cluster of users 400 via first digital channel 410 based on the weighting parameter. In some examples, the content distribution component provides second content 425 to a second portion of the first cluster of users 400 via first digital channel 410 based on a complement of the weighting parameter, where the treatment effect is computed based on the weighting parameter. For example, each of the a first portion of first cluster of users 400 second portion of the first cluster of users 400 may be a randomly chosen subset of first cluster of users 400, and the ratio of content distributed to the randomly chosen subsets of users is numerically reflected in the treatment effect by the weighting parameter a and the complement of the weighting parameter 1−α.

In some examples, the treatment effect component performs a covariate adjustment based on the treatment effect. For example, when there is an imbalance in respect of some covariate between user clusters, adjusting for the baseline effect leads to a more efficient treatment effect estimator. The treatment effect component may fit two linear least square estimators and combine regression coefficients obtained from them. Compared to conventional covariate adjustment, in which outcomes from a same group are chosen, the treatment effect component fits a model from outcomes of different groups. For example, the treatment effect component fits a model with outcomes of first content 420 from first cluster of users 400 (e.g., C1) and outcomes of second content 425 from second cluster of users 405 (e.g., C2) and vice versa. A vector of outcomes (e.g., conversion rates) Y̅₁^{C1}, Y̅₂^{C1}, Y̅₁^{C2}, Y̅₂^{C2} and the weighting parameter a are input to the treatment effect component. Where Z₁^{Cj}=δYᵢ^{Cj} (i.e., it is 1 if Y corresponds to first content 420 and 0 otherwise) and where the variable Z as an indicator of treatment allocation, the treatment effect component fits OLS ([Y₁^{C1}, Y₂^{C2}]˜X+1+[Z₁^{C1}, Z₂^{C2}]). Where β₁ is a coefficient of Z as estimated in the previous step, the treatment effect component fits OLS ([Y₁^{C1}, Y₂^{C2}]˜X+1+[Z₂^{C1}, Z₁^{C2}]). Where β₂ is a coefficient of Z as estimated in the previous step, the treatment effect component computes the covariate adjusted treatment effect:

$$= \frac{1}{2 α - 1} ( {αβ}_{1} + ( α - 1 ) {β}_{2} ) \qquad ( 8 )$$

The treatment effect component may estimate a cross-cluster treatment difference via regressing on the indicator Z and may combine the output of the two regression models to obtain a modified estimator.

In some examples, the monitoring component identifies a condition of users in first cluster of users 400 and second cluster of users 405. The monitoring component may monitor first digital content channel 410 to obtain a first conditional conversion rate for users in the first cluster of users 400 that satisfy the condition and receive first content 420 and a second conditional conversion rate for users in second cluster of users 405 that satisfy the condition and receive second content 425. The treatment effect component may compute a conditional average treatment effect based on the first conditional conversion rate and the second conditional conversion rate.

For example, content distributors would be interested in conditional effects to focus on users who have potentially high conversion rates. The monitoring component may identify conditional outcomes for the clusters of users, and the treatment effect component may use the treatment effect to obtain a conditional average treatment effect by replacing an average outcome with conditional average outcomes:

$$\vert X = \frac{1}{2 α - 1} ( α {\overline{Y}}_{1}^{C 1} \vert X + ( 1 - α ) {\overline{Y}}_{2}^{C 1} \vert X - ( 1 - α ) {\overline{Y}}_{1}^{C 2} \vert X - α {\overline{Y}}_{2}^{C 2} \vert X ) \qquad ( 9 )$$

The treatment effect component may estimate the conditionals via non-parametric regression, matching, or via propensity weighted estimators.

First content 420 is an example of, or includes aspects of, the corresponding element described with reference to FIG. 7.

### System Architecture

An apparatus for content distribution without tracking is described. One or more aspects of the apparatus include a clustering component configured to identify a first cluster of users and a second cluster of users, wherein each user in the first cluster and the second cluster receives digital content from a first digital content channel; a monitoring component configured to monitor user interactions on the first digital content channel to obtain a first conversion rate for users in the first cluster that receive first content and a second conversion rate for users in the second cluster that receive second content; and a treatment effect component configured to compute a cross-cluster treatment effect based on the first conversion rate and the second conversion rate, and a treatment effect for the first content based on the cross-cluster treatment effect.

Some examples of the apparatus further include a content distribution component configured to provide the first content and the second content via the first digital content channel. In some aspects, the content distribution component is configured to provide the first content and the second content via a second digital content channel.

FIG. 5 shows an example of a content distribution system according to aspects of the present disclosure. The example shown includes user 500, user device 505, content distribution apparatus 510, cloud 515, and database 520.

Referring to FIG. 5, a content distributor may want to distribute content on digital content channels with a reliable degree of foreknowledge of how many conversions the content will produce per user (the content's conversion rate). When a content distributor has access to information such as third-party cookies and mobile device identifiers, a content distributor can reliably predict conversions for particular individual users based on the users' past activity. However, the use of third-party cookies and mobile device identifiers for this purpose are being deprecated by prominent web browsers. The content distributor may instead use at least one embodiment of the inventive concept to determine that third-party cookies are not available, monitor user cluster activity on one or more digital content channels to identify conversion rates, determine a treatment effect based on the conversion rates, and distribute content to subsequent users, thereby distributing content using a reliable estimate of conversion rates even where user tracking is unavailable.

User device 505 may be a personal computer, laptop computer, mainframe computer, palmtop computer, personal assistant, mobile device, or any other suitable processing apparatus. In some examples, user device 505 includes software that communicates with content distribution apparatus 510, cloud 515, and database 520 to view content on digital content channels and to interact with the content and the digital content channels, such as by clicking on hyperlinks and entering information into data fields. In at least one embodiment, the software is a web browser.

A user interface may enable a user 500 to interact with user device 505. In some embodiments, the user interface may include an audio device, such as an external speaker system, an external display device such as a display screen, or an input device (e.g., a remote control device interfaced with the user interface directly or through an IO controller module). In some cases, the user interface may be a graphical user interface (GUI).

Content distribution apparatus 510 may include a computer implemented network. Content distribution apparatus 510 may also include one or more processors, a memory subsystem, a communication interface, an I/O interface, one or more user interface components, and a bus. Additionally, content distribution apparatus 510 may communicate with user device 505 and database 520 via cloud 515.

In some cases, content distribution apparatus 510 is implemented on a server. A server provides one or more functions to users 500 linked by way of one or more of the various networks. In some cases, the server includes a single microprocessor board, which includes a microprocessor responsible for controlling all aspects of the server. In some cases, a server uses microprocessor and protocols to exchange data with other devices or users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general purpose computing device, a personal computer, a laptop computer, a mainframe computer, a super computer, or any other suitable processing apparatus.

Further detail regarding the architecture of content distribution apparatus 510 is provided with reference to FIGS. 6-7. Further detail regarding a content distribution process is provided with reference to FIGS. 1-4.

A cloud such as cloud 515 is a computer network configured to provide on-demand availability of computer system resources, such as data storage and computing power. In some examples, the cloud 515 provides resources without active management by the user 500. The term cloud is sometimes used to describe data centers available to many users over the Internet. Some large cloud networks have functions distributed over multiple locations from central servers. A server is designated an edge server if it has a direct or close connection to a user. In some cases, a cloud is limited to a single organization. In other examples, the cloud is available to many organizations. In one example, cloud 515 includes a multi-layer communications network comprising multiple edge routers and core routers. In another example, cloud 515 is based on a local collection of switches in a single physical location.

A database such as database 520 is an organized collection of data. For example, a database stores data in a specified format known as a schema. Database 520 may be structured as a single database, a distributed database, multiple distributed databases, or an emergency backup database. In some cases, a database controller may manage data storage and processing in database 520. In some cases, user 500 interacts with the database controller. In other cases, the database controller may operate automatically without user interaction.

Referring to FIG. 5, content distribution apparatus 510 retrieves content from database 520 via cloud 515. In some embodiments, content distribution apparatus 510 retrieves content from other devices via cloud 515. In at least one embodiment, content distribution apparatus 510 and/or cloud 515 hosts one or more digital content channels. In at least one embodiment, the one or more digital content channels are hosted on other devices and/or networks. In at least one embodiment, content distribution apparatus 510 provides the content to the user 500 via the one or more digital content channels, cloud 515, and user device 505.

FIG. 6 shows an example of a content distribution apparatus according to aspects of the present disclosure. The example shown includes processor unit 600, memory unit 605, monitoring component 610, clustering component 615, content distribution component 620, and treatment effect component 625.

Processor unit 600 includes one or more processors. A processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, processor unit 600 is configured to operate a memory array using a memory controller. In other cases, a memory controller is integrated into processor unit 600. In some cases, processor unit 600 is configured to execute computer-readable instructions stored in memory unit 605 to perform various functions. In some embodiments, processor unit 600 includes special purpose components for modem processing, baseband processing, digital signal processing, or transmission processing.

Memory unit 605 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor of processor unit 600 to perform various functions described herein. In some cases, memory unit 605 contains, among other things, a basic input/output system (BIOS) which controls basic hardware or software operation such as the interaction with peripheral components or devices. In some cases, memory unit 605 includes a memory controller that operates memory cells of memory unit 605. For example, the memory controller may include a row decoder, column decoder, or both. In some cases, memory cells within memory unit 605 store information in the form of a logical state.

According to some aspects, monitoring component 610 determines that device identifiers used for user tracking are not available for a first digital content channel. In some examples, monitoring component 610 monitors user interactions on the first digital content channel to obtain a first conversion rate for users in the first cluster that receive the first content and a second conversion rate for users in the second cluster that receive the second content. In some examples, monitoring component 610 monitors the first digital content channel to obtain a third conversion rate for users in the first cluster that receive the second content and a fourth conversion rate for users in the second cluster that receive the first content. In some examples, monitoring component 610 identifies a condition of users in the first cluster and the second cluster. In some examples, monitoring component 610 monitors the first digital content channel to obtain a first conditional conversion rate for users in the first cluster that satisfy the condition and receive the first content and a second conditional conversion rate for users in the second cluster that satisfy the condition and receive the second content.

According to some aspects, monitoring component 610 monitors user interactions on the first digital content channel and the second digital content channel to obtain a first conversion rate for users in the first cluster that receive the first content, a second conversion rate for users in the second cluster that receive the second content, a third conversion rate for users in the first cluster that receive the third content, and a fourth conversion rate for users in the second cluster that receive the fourth content. In some examples, monitoring component 610 identifies a condition of users in the first cluster and the second cluster. In some examples, monitoring component 610 monitors the first digital content channel to obtain a first conditional conversion rate for users in the first cluster that satisfy the condition and receive the first content, a second conditional conversion rate for users in the second cluster that satisfy the condition and receive the second content, a third conversion rate for users in the first cluster than satisfy the condition and receive the third content, and a fourth conversion rate for users in the second cluster that satisfy the condition and receive the second content.

According to some aspects, monitoring component 610 is configured to monitor user interactions on the first digital content channel to obtain a first conversion rate for users in the first cluster that receive first content and a second conversion rate for users in the second cluster that receive second content. Monitoring component 610 is an example of, or includes aspects of, the corresponding element described with reference to FIG. 7.

According to some aspects, clustering component 615 identifies a first cluster of users and a second cluster of users based on the determination that device identifiers are not available, where each user in the first cluster and the second cluster receives digital content from the first digital content channel. In some examples, clustering component 615 identifies location information for users of the first digital content channel and the second digital content channel, where the first cluster and the second cluster are identified based on the location information.

According to some aspects, clustering component 615 identifies a first cluster of users and a second cluster of users based on determining that device identifiers used for user tracking are not available for a first digital content channel and a second digital content channel, where each user in the first cluster and the second cluster receives digital content from the first digital content channel or the second digital content channel.

According to some aspects, content distribution component 620 provides first content and second content via the first digital content channel. In some examples, content distribution component 620 provides the first content to a subsequent user based on the treatment effect. In some examples, content distribution component 620 identifies a weighting parameter. In some examples, content distribution component 620 provides the first content to a first portion of the first cluster via the first digital channel based on the weighting parameter. In some examples, content distribution component 620 provides the second content to a second portion of the first cluster via the first digital channel based on a complement of the weighting parameter, where the treatment effect is computed based on the weighting parameter. In some examples, content distribution component 620 provides the first content to a first portion of the second cluster via the first digital channel based on the complement of the weighting parameter. In some examples, content distribution component 620 provides the second content to a second portion of the second cluster via the first digital channel based on the weighting parameter. In some examples, content distribution component 620 provides the first content and the second content on a second digital content channel, where the cross-cluster treatment effect is based on providing the first content and the second content on the second digital content channel. In some examples, content distribution component 620 identifies a weighting parameter. In some examples, content distribution component 620 provides the first content to a first portion of the first cluster via the second digital channel based on a complement of the weighting parameter. In some examples, content distribution component 620 provides the second content to a second portion of the first cluster via the second digital channel based on the weighting parameter. In some examples, content distribution component 620 provides the first content to a first portion of the second cluster via the second digital channel based on the weighting parameter. In some examples, content distribution component 620 provides the second content to a second portion of the second cluster via the second digital channel based on a complement of the weighting parameter.

According to some aspects, content distribution component 620 provides first content and second content via the first digital content channel. In some examples, content distribution component 620 provides third content and fourth content via the second digital content channel. In some examples, content distribution component 620 provides the first content, the second content, the third content or the fourth content to a subsequent user based on the treatment effect. In some examples, content distribution component 620 identifies a weighting parameter. In some examples, content distribution component 620 provides the first content to a first portion of the first cluster via the first digital channel based on the weighting parameter. In some examples, content distribution component 620 provides the second content to a second portion of the first cluster via the first digital channel based on a complement of the weighting parameter, where the treatment effect is computed based on the weighting parameter. In some examples, content distribution component 620 provides the first content to a first portion of the second cluster via the first digital channel based on the complement of the weighting parameter. In some examples, content distribution component 620 provides the second content to a second portion of the second cluster via the first digital channel based on the weighting parameter. In some examples, content distribution component 620 provides the third content to a first portion of the first cluster via the second digital channel based on a complement of the weighting parameter. In some examples, content distribution component 620 provides the fourth content to a second portion of the first cluster via the second digital channel based on the weighting parameter. In some examples, content distribution component 620 provides the third content to a first portion of the second cluster via the second digital channel based on the weighting parameter. In some examples, content distribution component 620 provides the fourth content to a second portion of the second cluster via the second digital channel based on a complement of the weighting parameter.

According to some aspects, content distribution component 620 is configured to provide the first content and the second content via the first digital content channel. In some aspects, the content distribution component 620 is configured to provide the first content and the second content via a second digital content channel. Content distribution component 620 is an example of, or includes aspects of, the corresponding element described with reference to FIG. 7.

According to some aspects, treatment effect component 625 computes a cross-cluster treatment effect based on the first conversion rate and the second conversion rate. In some examples, treatment effect component 625 computes a treatment effect for the first content based on the cross-cluster treatment effect. In some examples, treatment effect component 625 computes an additional cross-cluster treatment effect based on the third conversion rate and the fourth conversion rate. In some examples, treatment effect component 625 weights the cross-cluster treatment effect and the additional cross-cluster treatment effect, where the treatment effect is based on the weighted cross-cluster treatment effect and the weighted additional cross-cluster treatment effect. In some examples, treatment effect component 625 performs a covariate adjustment based on the treatment effect. In some examples, treatment effect component 625 computes a conditional average treatment effect based on the first conditional conversion rate and the second conditional conversion rate.

According to some aspects, treatment effect component 625 computes cross-cluster treatment effect based on the first conversion rate, the second conversion rate, the third conversion rate, and the fourth conversion rate. In some examples, treatment effect component 625 computes a treatment effect for the first content, the second content, the third content and the fourth content based on the cross-cluster treatment effect. In some examples, treatment effect component 625 performs a covariate adjustment on the treatment effect. In some examples, treatment effect component 625 computes conditional average treatment effects based on the first conditional conversion rate, the second conditional conversion rate, the third conditional conversion rate, and the fourth conditional conversion rate.

According to some aspects, treatment effect component 625 is configured to compute a cross-cluster treatment effect based on the first conversion rate and the second conversion rate, and a treatment effect for the first content based on the cross-cluster treatment effect. Treatment effect component 625 is an example of, or includes aspects of, the corresponding element described with reference to FIG. 7.

FIG. 7 shows an example of computing a treatment effect according to aspects of the present disclosure. The example shown includes user interactions 700, monitoring component 705, first conversion rate 710, second conversion rate 715, treatment effect component 720, treatment effect 725, content distribution component 730, and first content 735.

Referring to FIG. 7, monitoring component 705 monitors user interactions 700 to determined first conversion rate 710 and second conversion rate 715. Treatment effect component 720 determines treatment effect 725 based on first conversion rate 710 and second conversion rate 715. Content distribution component 730 distributes first content 735 based on treatment effect 725.

Monitoring component 705 is an example of, or includes aspects of, the corresponding element described with reference to FIG. 6. Treatment effect component 720 is an example of, or includes aspects of, the corresponding element described with reference to FIG. 6. Content distribution component 730 is an example of, or includes aspects of, the corresponding element described with reference to FIG. 6. First content 735 is an example of, or includes aspects of, the corresponding element described with reference to FIG. 4.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method for content distribution, comprising:
determining, by a monitoring component, that device identifiers used for user tracking are not available for a first digital content channel;
identifying, by a clustering component, a first cluster of users and a second cluster of users based on the determination that device identifiers are not available, wherein each user in the first cluster and the second cluster receives digital content from the first digital content channel;
providing, by a content distribution component, first content and second content via the first digital content channel;
monitoring, by the monitoring component, user interactions on the first digital content channel to obtain a first conversion rate for users in the first cluster that receive the first content and a second conversion rate for users in the second cluster that receive the second content;
computing, by a treatment effect component, a cross-cluster treatment effect based on the first conversion rate and the second conversion rate;
computing, by the treatment effect component, a treatment effect for the first content based on the cross-cluster treatment effect; and
providing, by the content distribution component, the first content to a subsequent user based on the treatment effect.

2. The method of claim 1, further comprising:
monitoring, by the monitoring component, the first digital content channel to obtain a third conversion rate for users in the first cluster that receive the second content and a fourth conversion rate for users in the second cluster that receive the first content;
computing, by the treatment effect component, an additional cross-cluster treatment effect based on the third conversion rate and the fourth conversion rate; and
weighting, by the treatment effect component, the cross-cluster treatment effect and the additional cross-cluster treatment effect, wherein the treatment effect is based on the weighted cross-cluster treatment effect and the weighted additional cross-cluster treatment effect.

3. The method of claim 1, further comprising:
identifying, by the content distribution component, a weighting parameter;
providing, by the content distribution component, the first content to a first portion of the first cluster via the first digital channel based on the weighting parameter; and
providing, by the content distribution component, the second content to a second portion of the first cluster via the first digital channel based on a complement of the weighting parameter, wherein the treatment effect is computed based on the weighting parameter.

4. The method of claim 3, further comprising:
providing, by the content distribution component, the first content to a first portion of the second cluster via the first digital channel based on the complement of the weighting parameter; and
providing, by the content distribution component, the second content to a second portion of the second cluster via the first digital channel based on the weighting parameter.

5. The method of claim 1, further comprising:
providing, by the content distribution component, the first content and the second content on a second digital content channel, wherein the cross-cluster treatment effect is based on providing the first content and the second content on the second digital content channel.

6. The method of claim 5, further comprising:
identifying, by the content distribution component, a weighting parameter;
providing, by the content distribution component, the first content to a first portion of the first cluster via the second digital channel based on a complement of the weighting parameter; and
providing, by the content distribution component, the second content to a second portion of the first cluster via the second digital channel based on the weighting parameter.

7. The method of claim 6, further comprising:
providing, by the content distribution component, the first content to a first portion of the second cluster via the second digital channel based on the weighting parameter; and
providing, by the content distribution component, the second content to a second portion of the second cluster via the second digital channel based on a complement of the weighting parameter.

8. The method of claim 1, further comprising:
performing, by the treatment effect component, a covariate adjustment based on the treatment effect.

9. The method of claim 1, further comprising:
identifying, by the monitoring component, a condition of users in the first cluster and the second cluster;
monitoring, by the monitoring component, the first digital content channel to obtain a first conditional conversion rate for users in the first cluster that satisfy the condition and receive the first content and a second conditional conversion rate for users in the second cluster that satisfy the condition and receive the second content; and
computing, by the treatment effect component, a conditional average treatment effect based on the first conditional conversion rate and the second conditional conversion rate.

10. The method of claim 1, further comprising:
identifying location information for users of the first digital content channel and a second digital content channel, wherein the first cluster and the second cluster are identified based on the location information.

11. A method for content distribution, comprising:
identifying, by a clustering component, a first cluster of users and a second cluster of users based on determining that device identifiers used for user tracking are not available for a first digital content channel and a second digital content channel, wherein each user in the first cluster and the second cluster receives digital content from the first digital content channel or the second digital content channel;
providing, by a content distribution component, first content and second content via the first digital content channel;
providing, by the content distribution component, third content and fourth content via the second digital content channel;
monitoring, by a monitoring component, user interactions on the first digital content channel and the second digital content channel to obtain a first conversion rate for users in the first cluster that receive the first content, a second conversion rate for users in the second cluster that receive the second content, a third conversion rate for users in the first cluster that receive the third content, and a fourth conversion rate for users in the second cluster that receive the fourth content;
computing, by a treatment effect component, a cross-cluster treatment effect based on the first conversion rate, the second conversion rate, the third conversion rate, and the fourth conversion rate;
computing, by the treatment effect component, a treatment effect for the first content, the second content, the third content and the fourth content based on the cross-cluster treatment effect; and
providing, by the content distribution component, the first content, the second content, the third content or the fourth content to a subsequent user based on the treatment effect.

12. The method of claim 11, further comprising:
identifying, by the content distribution component, a weighting parameter;
providing, by the content distribution component, the first content to a first portion of the first cluster via the first digital channel based on the weighting parameter; and
providing, by the content distribution component, the second content to a second portion of the first cluster via the first digital channel based on a complement of the weighting parameter, wherein the treatment effect is computed based on the weighting parameter.

13. The method of claim 12, further comprising:
providing, by the content distribution component, the first content to a first portion of the second cluster via the first digital channel based on the complement of the weighting parameter; and
providing, by the content distribution component, the second content to a second portion of the second cluster via the first digital channel based on the weighting parameter.

14. The method of claim 13, further comprising:
providing, by the content distribution component, the third content to a first portion of the first cluster via the second digital channel based on a complement of the weighting parameter; and
providing, by the content distribution component, the fourth content to a second portion of the first cluster via the second digital channel based on the weighting parameter.

15. The method of claim 14, further comprising:
providing, by the content distribution component, the third content to a first portion of the second cluster via the second digital channel based on the weighting parameter; and
providing, by the content distribution component, the fourth content to a second portion of the second cluster via the second digital channel based on a complement of the weighting parameter.

16. The method of claim 11, further comprising:
performing, by the treatment effect component, a covariate adjustment on the treatment effect.

17. The method of claim 11, further comprising:
identifying, by the monitoring component, a condition of users in the first cluster and the second cluster;
monitoring, by the monitoring component, the first digital content channel to obtain a first conditional conversion rate for users in the first cluster that satisfy the condition and receive the first content, a second conditional conversion rate for users in the second cluster that satisfy the condition and receive the second content, a third conversion rate for users in the first cluster than satisfy the condition and receive the third content, and a fourth conversion rate for users in the second cluster that satisfy the condition and receive the second content; and
computing, by the treatment effect component, conditional average treatment effects based on the first conditional conversion rate, the second conditional conversion rate, the third conditional conversion rate, and the fourth conditional conversion rate.

18. An apparatus for content distribution, comprising:
a clustering component configured to identify a first cluster of users and a second cluster of users, wherein each user in the first cluster and the second cluster receives digital content from a first digital content channel;
a monitoring component configured to monitor user interactions on the first digital content channel to obtain a first conversion rate for users in the first cluster that receive first content and a second conversion rate for users in the second cluster that receive second content; and
a treatment effect component configured to compute a cross-cluster treatment effect based on the first conversion rate and the second conversion rate, and a treatment effect for the first content based on the cross-cluster treatment effect.

19. The apparatus of claim 18, further comprising:
a content distribution component configured to provide the first content and the second content via the first digital content channel.

20. The apparatus of claim 19, wherein:
the content distribution component is configured to provide the first content and the second content via a second digital content channel.
